(19) United States
(12) Patent Application Publication
(10) Pub. No.: US 2017/0097762 A1
(43) Pub. Date: Apr. 6, 2017

(54) INFORMATION PROCESSING APPARATUS, INFORMATION PROCESSING METHOD, AND INFORMATION PROCESSING PROGRAM

(71) Applicant: NEC Corporation, Minato-ku, Tokyo (JP)

(72) Inventor: Hotaka SUGANO, Tokyo (JP)

(73) Assignee: NEC Corporation, Minato-ku, Tokyo (JP)

(21) Appl. No.: 15/125,270

(22) PCT Filed: Dec. 22, 2014
(86) PCT No.: PCT/JP2014/083984

§ 371 Date: Sep. 12, 2016

(30) Foreign Application Priority Data
Mar. 20, 2014 (JP) 2014-059239

(51) Int. Cl. G06F 3/0488; G06F 3/0485

(52) U.S. Cl. CPC G06F 3/04883; G06F 3/0485; G06F 2203/04803

(57) ABSTRACT

An apparatus according to this invention is an information processing apparatus for implementing more user-friendly screen control. The information processing apparatus has as its feature to acquire a stroke of a user operation on a touch panel, and lock a scroll operation by the stroke, if the operation by the stroke is estimated to draw a contour of a closed region. Furthermore, the information processing apparatus has as its feature to release the lock of the scroll operation if the operation by the stroke is not estimated to draw the contour of the closed region. The estimation processing is performed based on the moving amount of the stroke.

### TECHNICAL FIELD

The present invention relates to an information processing apparatus, an information processing method, and an information processing program.

### BACKGROUND ART

In the above technical field, a technique described in patent literature 1 acquires coordinate values in the horizontal and vertical directions of a touch point during a drag operation on a touch screen. When a touch start point is set as an origin, if at least one of the coordinate values is smaller than a predetermined threshold, at least one of the moving amounts in the horizontal and vertical directions of the drag operation is reset to zero.

### CITATION LIST

### Patent Literature

Patent literature 1: Japanese Patent Laid-Open No. 2013-092942

### SUMMARY OF THE INVENTION

### Technical Problem

However, the technique described in the above literature cannot implement scroll lock control in accordance with a shape estimated to be drawn by a stroke, and thus cannot achieve sufficiently user-friendly screen control.

The present invention enables to provide a technique of solving the above-described problem.

### Solution to Problem

One aspect of the present invention provides an information processing apparatus that acquires a stroke from a user operation on a touch panel, and locks a scroll operation by the stroke, if the user operation by the stroke is estimated to draw a contour of a closed region.

Another aspect of the present invention provides an information processing method comprising:

acquiring a stroke from a user operation on a touch panel;

determining whether the operation by the stroke can be estimated to draw a contour of a closed region; and

locking a scroll operation by the stroke, if the operation by the stroke is estimated to draw the contour of the closed region.

Still other aspect of the present invention provides an information processing program for causing a computer to execute a method, comprising:

acquiring a stroke from a user operation on a touch panel;

determining whether the operation by the stroke can be estimated to draw a contour of a closed region; and

locking a scroll operation by the stroke, if the operation by the stroke is estimated to draw the contour of the closed region.

### Advantageous Effects of Invention

According to the present invention, it is possible to implement more user-friendly screen control.

### BRIEF DESCRIPTION OF DRAWINGS

FIG. 1 is a block diagram showing the arrangement of an information processing apparatus according to the first embodiment of the present invention;

FIG. 2 is a view showing an overview of processing by an information processing apparatus according to the second embodiment of the present invention;

FIG. 3 is a view showing an overview of processing by an information processing apparatus according to a technical premise;

FIG. 4A is a view showing the outer appearance of the information processing apparatus according to the second embodiment of the present invention;

FIG. 4B is a block diagram showing the arrangement of the information processing apparatus according to the second embodiment of the present invention;

FIG. 5 is a block diagram showing the functional arrangement of a screen operation processor according to the second embodiment of the present invention;

FIG. 6 is a block diagram showing the functional arrangement of an operation acceptor according to the second embodiment of the present invention;

FIG. 7 is a block diagram showing the functional arrangement of an operation analyzer according to the second embodiment of the present invention;

FIG. 8A is a block diagram showing the functional arrangement of a user operation determiner according to the second embodiment of the present invention;

FIG. 8B is a table showing the arrangement of a scroll lock condition storage unit according to the second embodiment of the present invention;

FIG. 8C is a view for explaining stroke analysis processing by a scroll lock determiner according to the second embodiment of the present invention;

FIG. 8D is a view for explaining the stroke analysis processing by the scroll lock determiner according to the second embodiment of the present invention;

FIG. 8E is a view for explaining the stroke analysis processing by the scroll lock determiner according to the second embodiment of the present invention;

FIG. 8F is a view for explaining the stroke analysis processing by the scroll lock determiner according to the second embodiment of the present invention;

FIG. 9 is a block diagram showing the functional arrangement of a display controller according to the second embodiment of the present invention;

FIG. 10 is a flowchart illustrating the procedure of screen operation processing by the information processing apparatus according to the second embodiment of the present invention;

FIG. 11 is a flowchart illustrating the procedure of stroke analysis processing according to the second embodiment of the present invention;

FIG. 12 is a flowchart illustrating the procedure of stroke analysis processing according to the third embodiment of the present invention;

FIG. 13 is a flowchart illustrating the procedure of screen operation processing by an information processing apparatus according to the fourth embodiment of the present invention; and

FIG. 14 is a view for explaining stroke analysis processing by an information processing apparatus according to the fifth embodiment of the present invention.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

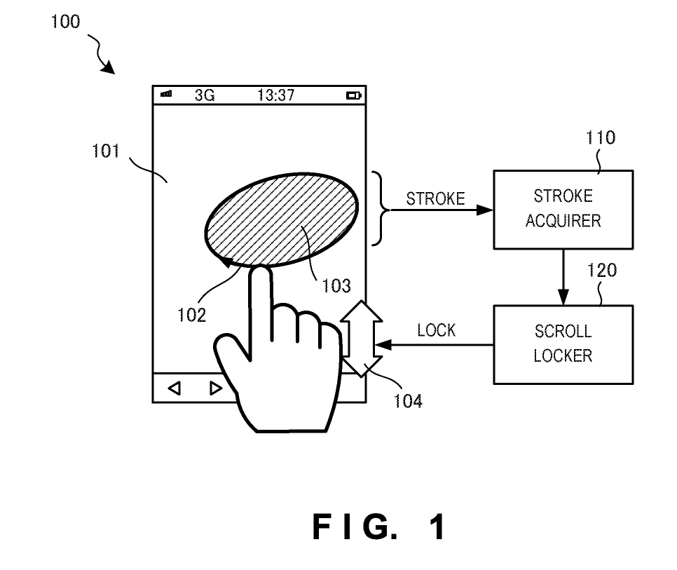

An information processing apparatus 100 according to the first embodiment of the present invention will be described with reference to FIG. 1. As shown in FIG. 1, the information processing apparatus 100 includes a stroke acquirer 110 and a scroll locker 120. The stroke acquirer 110 acquires a stroke 102 of a user operation on a touch panel 101. The scroll locker 120 determines whether the stroke 102 acquired by the stroke acquirer 110 draws the contour of a closed region 103. If the stroke 102 is estimated to draw the contour of the closed region 103, the scroll locker 120 locks a scroll operation 104 by the stroke 102 on the screen.

If the stroke acquirer 110 acquires the stroke 102, the scroll locker 120 determines a condition such as the direction of the stroke 102, the accumulation of vertical and horizontal components, the ratio between the vertical and horizontal components, or the main vector. Under the condition, the stroke of the user is estimated to generate a selected range of a closed region at the beginning, thereby determining to lock scroll.

This can perform scroll lock control in accordance with a shape estimated to be drawn by a stroke, thereby implementing sufficiently user-friendly scroll control.

### Second Embodiment

An information processing apparatus according to the second embodiment of the present invention will be described next. If the information processing apparatus according to this embodiment acquires a stroke of a user operation on a touch panel, and estimates the operation by the stroke to draw the contour of a closed region, it locks a scroll operation by the stroke. In this example, based on the ratio between the moving amount in the horizontal direction and that in the vertical direction in a stroke operation, the apparatus estimates that the contour of a closed region is to be drawn.

<<Processing of Technical Premise>>

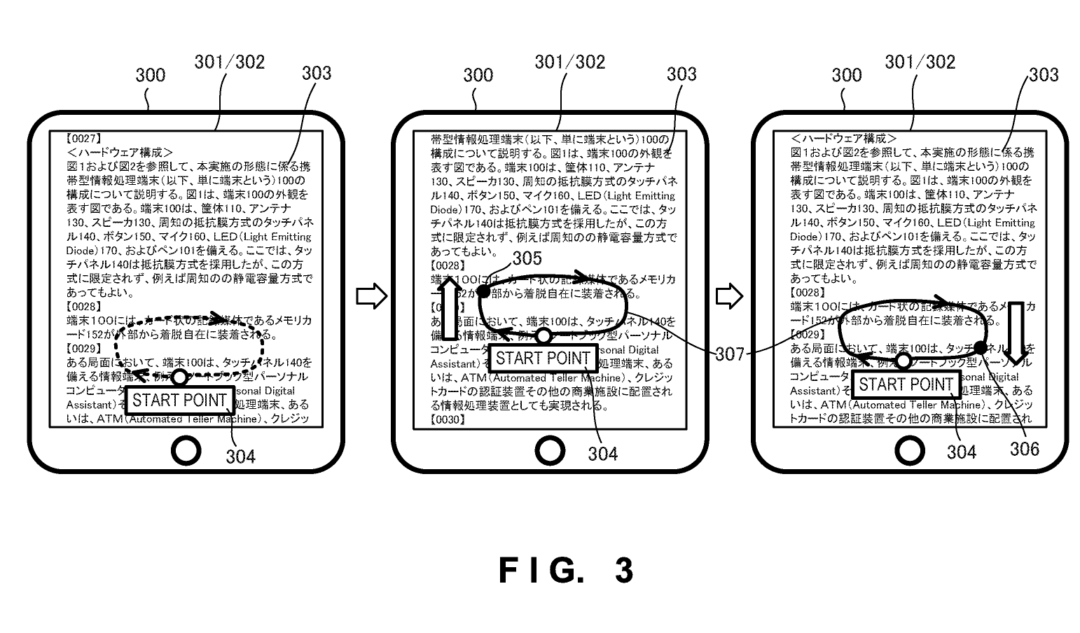

Before a description of this embodiment, FIG. 3 shows an overview of processing by an information processing apparatus 300 according to a technical premise.

In the left view of FIG. 3, to designate a selected range of a closed region while a document 303 is displayed on a display panel 301 of the information processing apparatus 300, the user is to draw a closed curve 307 from a start point 304 on a touch panel 302. The central view of FIG. 3 shows a state in which a user's finger has come to a point 305. At this time, since the user's finger has moved upward, the document 303 is scrolled upward. The right view of FIG. 3 shows a state in which the user's finger has come to a point 306. At this time, since the user's finger has moved downward, the document 303 is scrolled downward.

In this way, the document 303 on the display panel 301 is scrolled. Therefore, the user cannot accurately designate a selected range of a closed region.

<<Processing of Embodiment>>

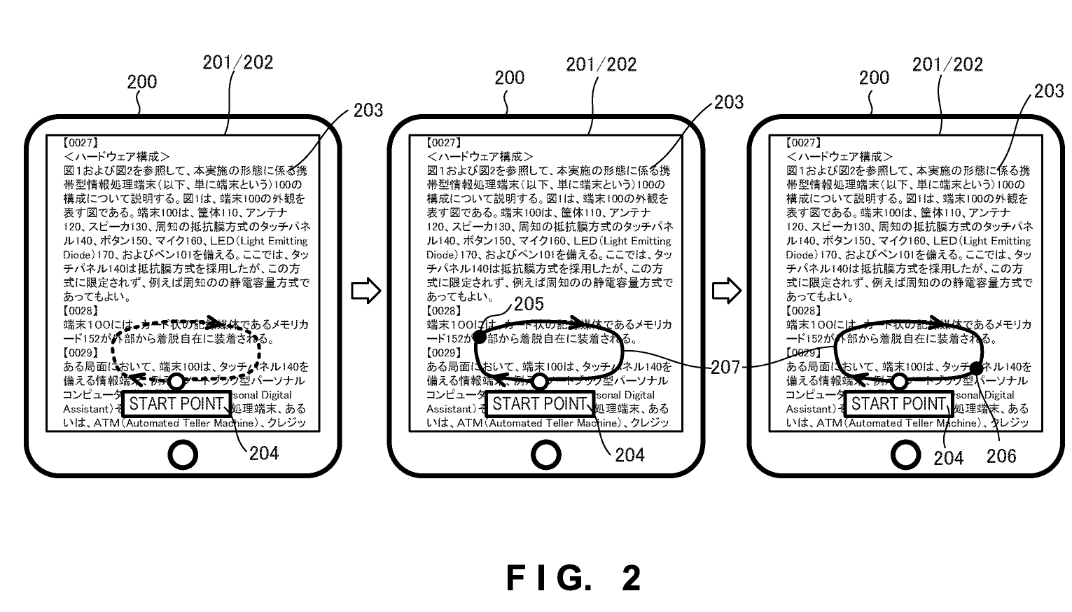

FIG. 2 is a view showing an overview of processing by an information processing apparatus 200 according to this embodiment.

In the left view of FIG. 2, to designate a selected range of a closed region while a document 203 is displayed on a display panel 202 of the information processing apparatus 200, the user is to draw a closed curve 207 from a start point 204 on a touch panel 201. The central view of FIG. 2 shows a state in which a user's finger has come to a point 205. At this time, the user's finger has moved upward. However, the information processing apparatus 200 determines designation of the selected range of the closed region to lock scroll of display of the document 203, and thus the selected range can be designated in the same screen state. Furthermore, in a state shown in the right view of FIG. 2 in which the user's finger has come to a point 206, the user's finger has moved downward. However, the information processing apparatus 200 determines designation of the selected range of the closed region to lock scroll of display of the document 203, and thus the selected range can be designated in the same screen state.

As described above, if it is determined that a selected range of a closed region is to be designated, the information processing apparatus 200 locks scroll of the document 203 on the display panel 202, thereby allowing the user to accurately designate the selected range of the closed region.

<<Information Processing Apparatus>>

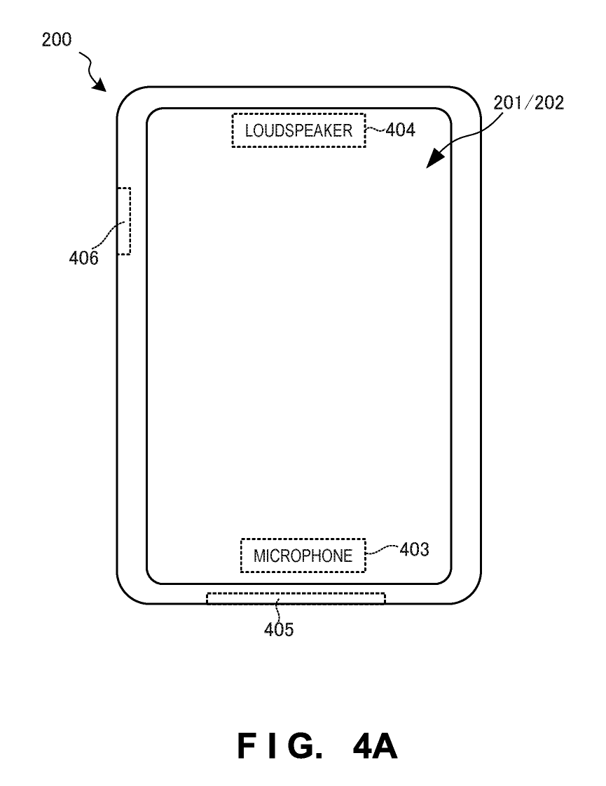

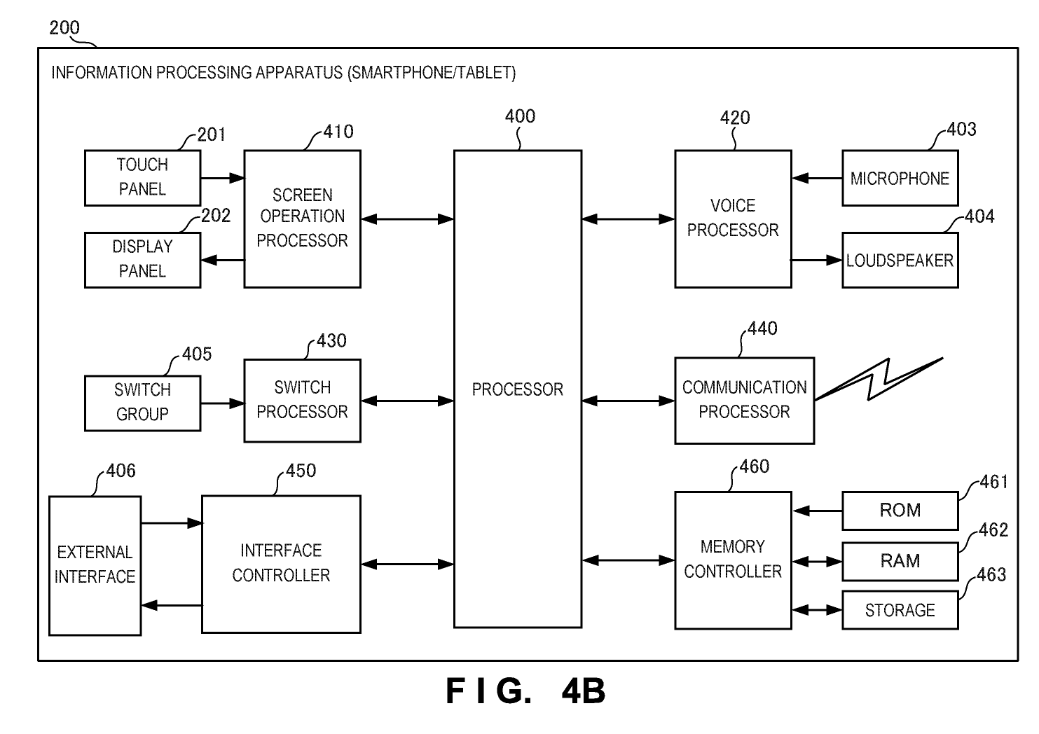

FIG. 4A is a view showing the outer appearance of the information processing apparatus 200 according to this embodiment. Note that FIG. 4A shows a portable terminal using a touch panel, such as a smartphone or tablet. However, the information processing apparatus is not limited to the smartphone, the tablet, or the like, and any information processing apparatus using a touch panel can be adopted.

In the information processing apparatus 200, the touch panel 201 and the display panel 202 function as an operation unit and a display unit, respectively. The information processing apparatus 200 includes a microphone 403 and a loudspeaker 404 as a voice input/output function. The information processing apparatus 200 also includes a switch group 405 including a power switch. Furthermore, the information processing apparatus 200 includes an external interface 406 used for external input/output device connection and communication connection.

(Functional Arrangement of Information Processing Apparatus)

FIG. 4B is a block diagram showing the arrangement of the information processing apparatus 200 according to this embodiment. Note that FIG. 4B shows the basic arrangement of the portable terminal using the touch panel, such as a smartphone or tablet. The present invention, however, is not limited to this. Each component shown in FIG. 4B may be implemented by a single hardware component, software by including a proprietary processor to execute a program, or firmware by combining hardware and software. Each component shown in FIG. 4B is separated from other components to independently implement its function. In fact, however, each component is implemented by a combination of multilayer controls from bottom layer control by basic hardware and OS (Operating System) and input/output control to top layer control by an application program.

A processor 400 includes at least one CPU (Central Processing Unit), and controls the overall information processing apparatus 200. Note that the processor 400 desirably incorporates a unique memory. A screen operation processor 410 is a component for performing processing according to this embodiment. The screen operation processor 410 accepts a user operation input from the touch panel 201, changes a display screen in correspondence with the user operation input, and displays the screen on the display panel 202. Note that the screen operation processor 410 may be implemented by executing an associated program by the processor 400 but an independent screen operation processor is desirably provided. A voice processor 420 processes a voice input from the microphone 403 to, for example, transmit the voice input via a communication processor 440 or send a user voice instruction changed to a user operation input from the touch panel 201. The voice processor 420 generates a notification/warning to the user, a video reproduction voice, or the like, and outputs a voice from the loudspeaker. The voice processor 420 is also desirably provided with a voice processing processor independent of the processor 400.

A switch processor 430 executes processing based on a switch input from the switch group 405. The communication processor 440 transmits/receives data via a network. An interface controller 450 controls data input/output to/from an input/output device connected via the external interface 406. The communication processor 440 is also desirably provided with a voice processing processor independent of the processor 400. For example, a memory controller 460 controls exchange of data and programs between the processor 400 and a ROM (Read Only Memory) 461 which is formed by a flash memory and the like, a RAM (Random Access Memory) 462, and a storage 463. The memory controller 460 is also desirably provided with a voice processing processor independent of the processor 400.

The screen operation processor 410 according to this embodiment will be described in more detail below.

(Screen Operation Processor)

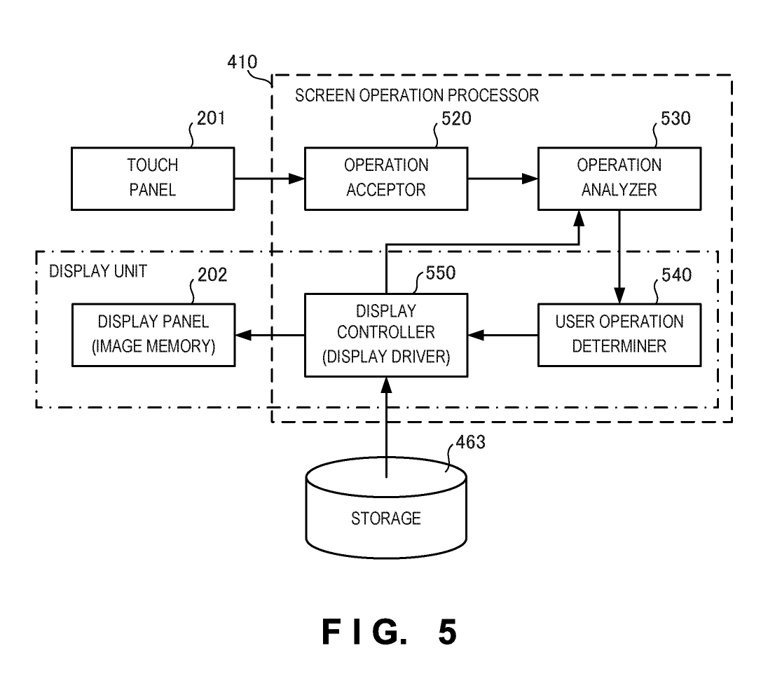

FIG. 5 is a block diagram showing the functional arrangement of the screen operation processor 410 according to this embodiment.

The screen operation processor 410 includes an operation acceptor 520, an operation analyzer 530, a user operation determiner 540, and a display controller 550. The operation acceptor 520 accepts a user operation from the touch panel 201, and acquires a touch position and an operation. The operation analyzer 530 analyzes operation contents in consideration of information of the display screen based on the user operation and position accepted by the operation acceptor 520. In this embodiment, the operation analyzer 530 especially analyzes data associated with a stroke necessary to estimate that the contour of a closed region is to drawn. Based on the operation contents analyzed by the operation analyzer 530, the user operation determiner 540 determines an operation desired by the user. In this embodiment, the user operation determiner 540 performs scroll control including a scroll lock operation. The display controller 550 includes a display driver. The display controller 550 reads out a content including a document from the storage 463, and controls screen display on the display panel 202 in accordance with the determination result of the user operation determiner 540. Under the control of the display controller 550, the operation desired by the user can be implemented on the display screen.

Note that the functional components shown in FIG. 5 may be implemented by the processing of the processor of the screen operation processor 410, or some functional components may be processed by a proprietary processor to increase the processing speed. Each functional component shown in FIG. 5 is limited to the operation of the screen operation processor 410 but may exchange data with other components of the information processing apparatus 200 shown in FIG. 4B.

(Operation Acceptor)

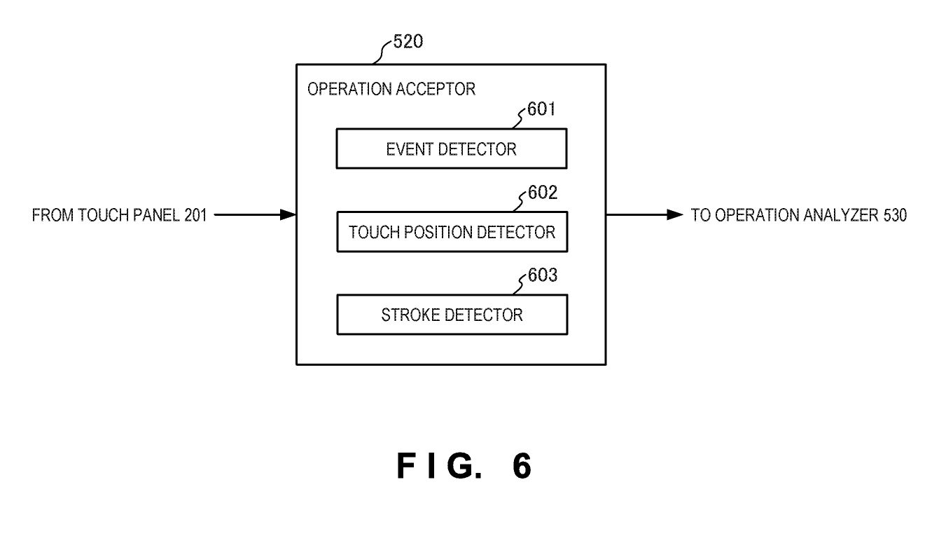

FIG. 6 is a block diagram showing the functional arrangement of the operation acceptor 520 according to this embodiment. The operation acceptor 520 accepts a user operation from the touch panel 201, and acquires a touch position and an operation.

The operation acceptor 520 includes an event detector 601, a touch position detector 602, and a stroke detector 603. The event detector 601 detects the start of some operation from the user on the touch panel 201, and starts accepting operation data. The touch position detector 602 detects position coordinates on the touch panel 201 touched by a user's finger. The stroke detector 603 detects a stroke as a locus from the start point of a user touch to its end point based on a temporal change of the touch.

(Operation Analyzer)

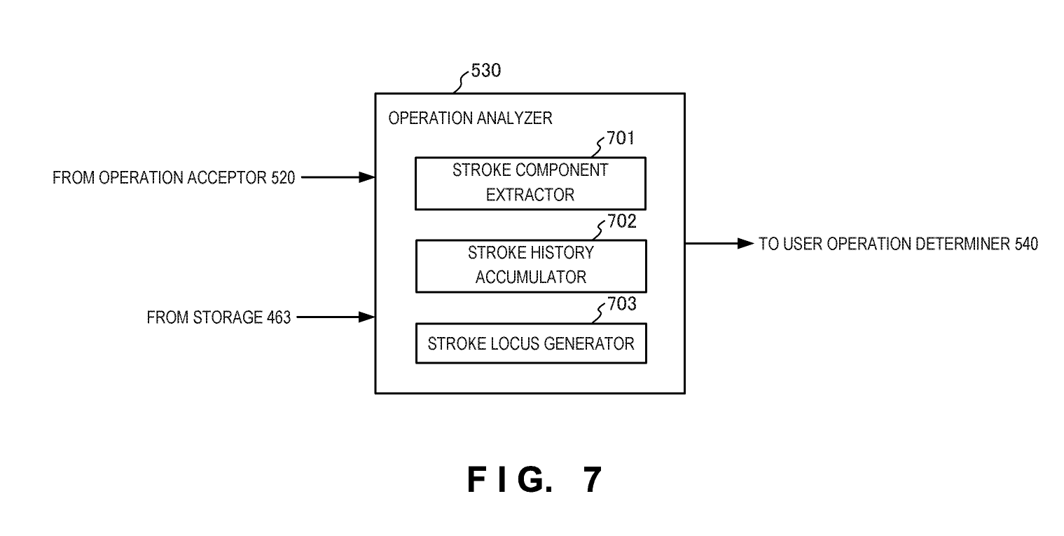

FIG. 7 is a block diagram showing the functional arrangement of the operation analyzer 530 according to this embodiment. The operation analyzer 530 analyzes operation contents in consideration of the information of the display screen based on the user operation and position accepted by the operation acceptor 520.

The operation analyzer 530 includes a stroke component extractor 701, a stroke history accumulator 702, and a stroke locus generator 703. The stroke component extractor 701 extracts a component of the stroke detected by the stroke detector 603 of the operation acceptor 520. For example, the stroke component extractor 701 extracts components in the horizontal and vertical directions of the touch panel 201, a direction component from the start point of the stroke to the current point, or the like. The stroke history accumulator 702 accumulates the coordinates of the path of the stroke, velocities, or the like. The stroke locus generator 703 generates the locus of the stroke from the accumulated stroke history.

(User Operation Determiner)

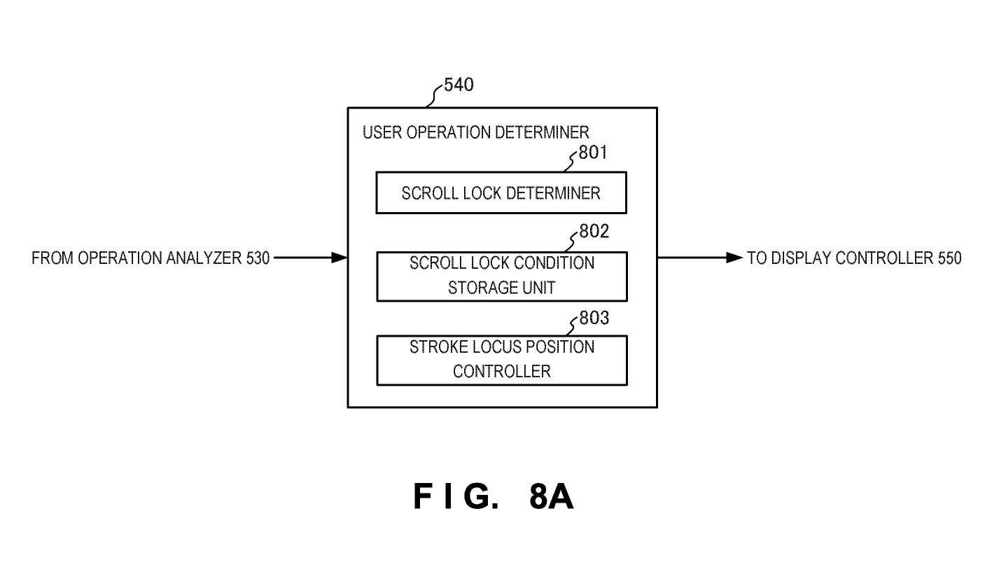

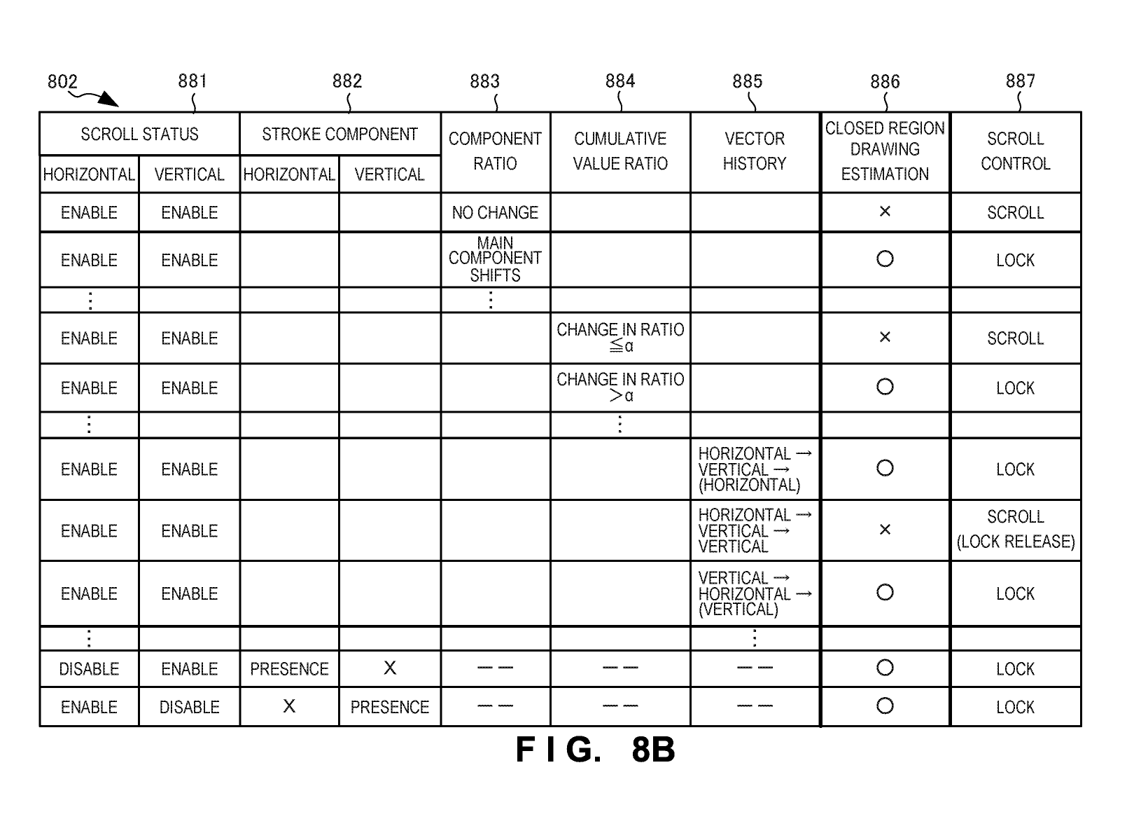

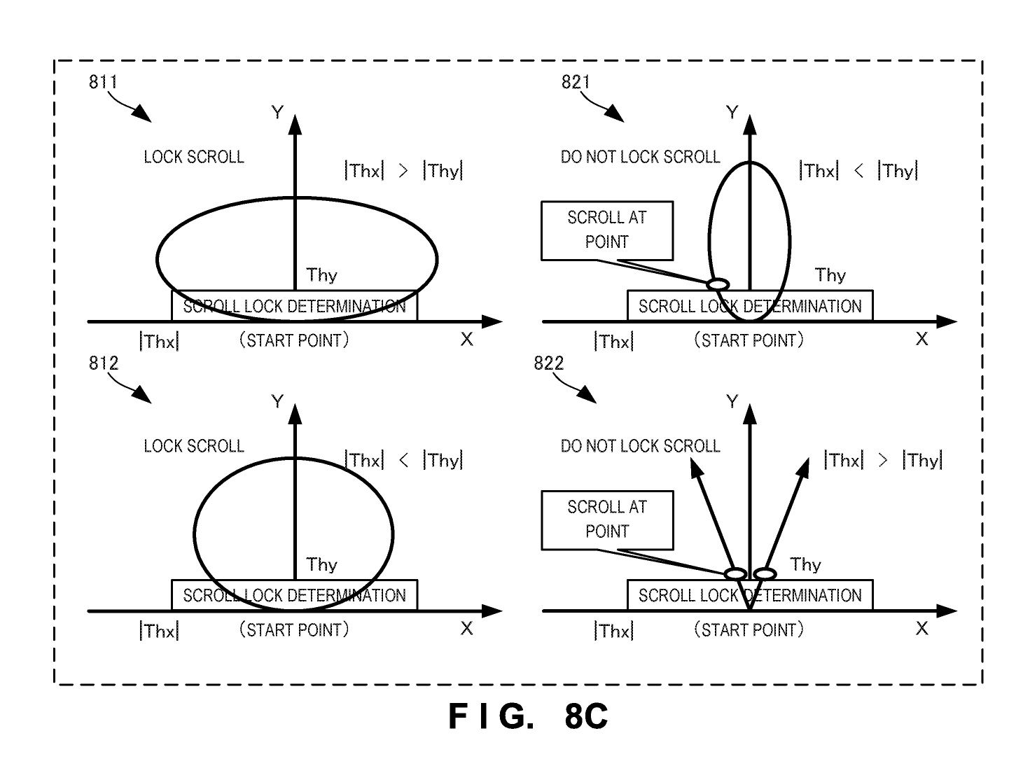

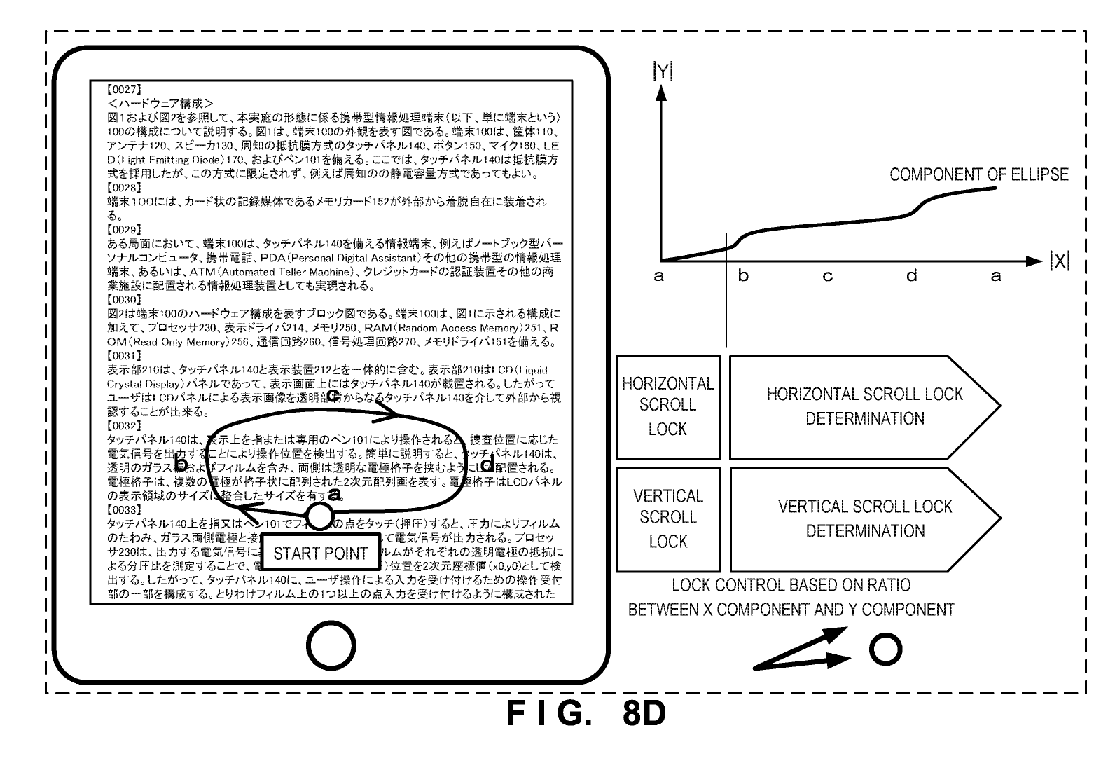

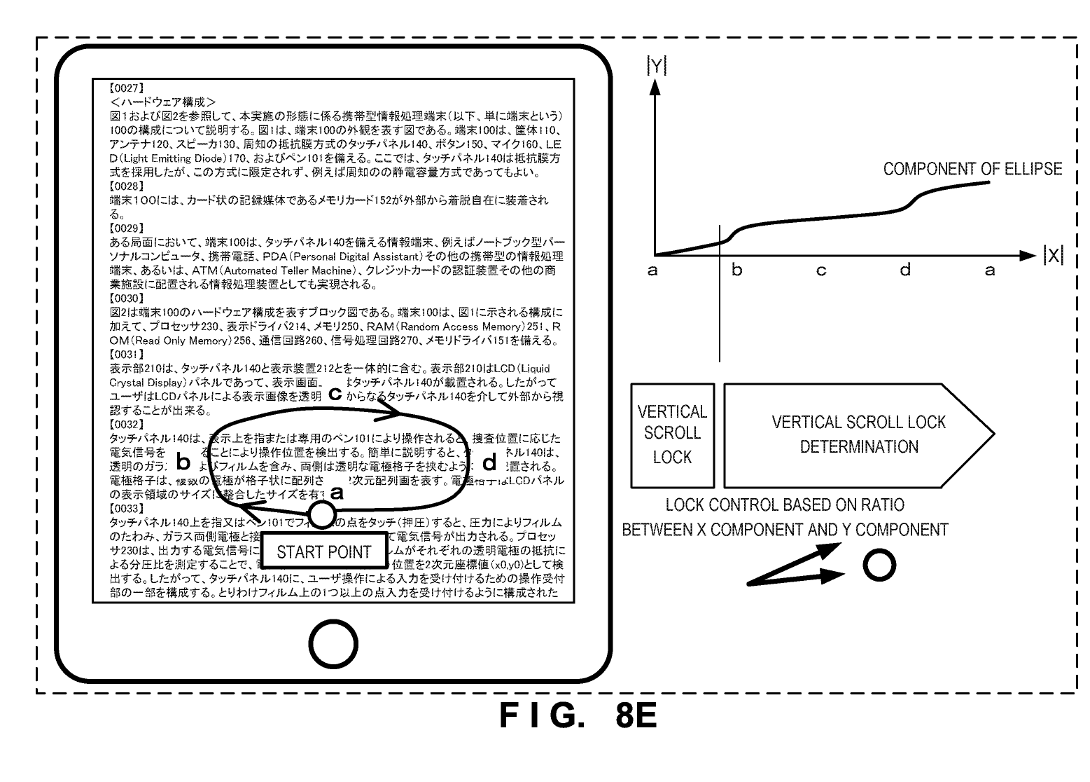

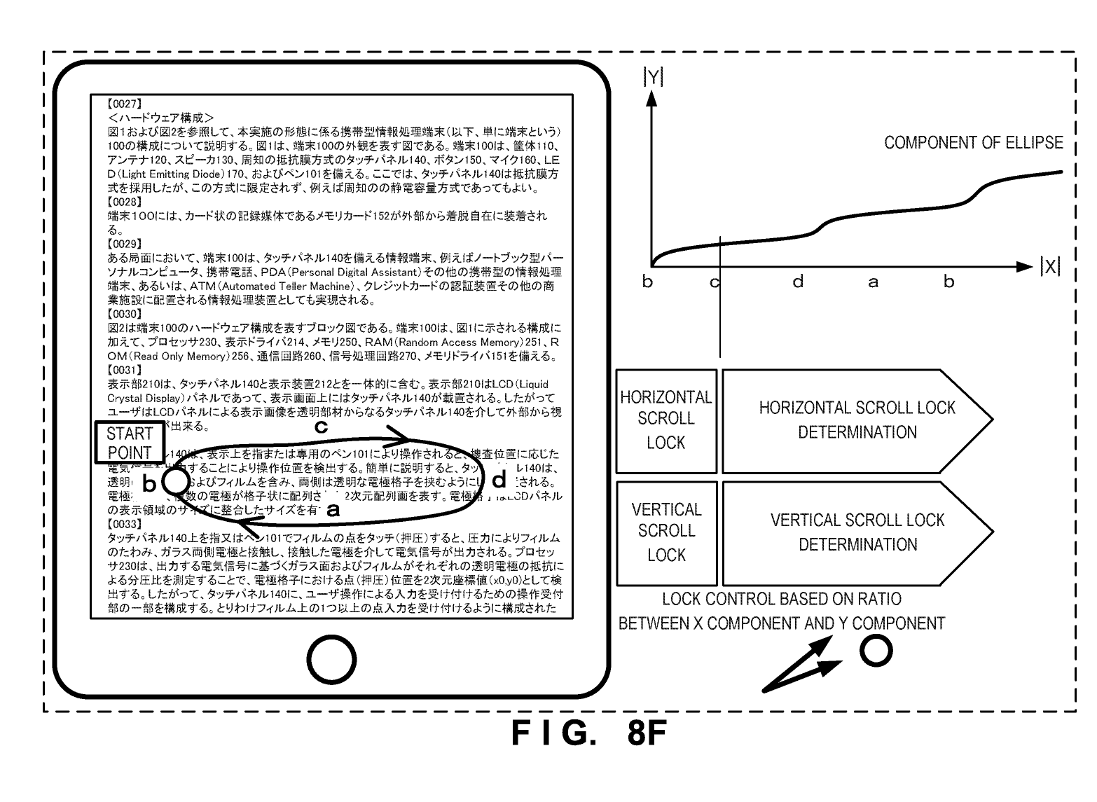

FIG. 8A is a block diagram showing the functional arrangement of the user operation determiner 540 according to this embodiment. Based on the operation contents analyzed by the operation analyzer 530, the user operation determiner 540 determines an operation desired by the user. In this embodiment, the user operation determiner 540 performs scroll control including a scroll lock operation.

The user operation determiner 540 includes a scroll lock determiner 801, a scroll lock condition storage unit 802, and a stroke locus position controller 803. The scroll lock determiner 801 controls a scroll lock operation and a scroll release operation with reference to a condition for locking scroll stored in the scroll lock condition storage unit 802. The scroll lock condition storage unit 802 stores a condition for locking scroll, by estimating the stroke of the user to generate a selected range of a closed region at the beginning under the condition such as the direction of the stroke of the user, the accumulation of vertical and horizontal components, the ratio between the vertical and horizontal components, or the main vector. The stroke locus position controller 803 is used to prevent, in advance, an error from occurring in estimation of generation of a selected range due to a fluctuation occurred in the middle of the stroke. For example, the fluctuation may occur when the user cannot accurately draw a straight line or circle, and the vertical and horizontal components may have no predetermined tendency. For example, if a shift width does not exceed a threshold or a fluctuation temporarily occurs, the stroke locus position controller 803 controls to delete the fluctuation from the determination condition for estimation of a selected range at the time of returning. As simple stroke locus position control, for example, a solution of obtaining an average value depending on a predetermined stroke length can be used.

(Scroll Lock Condition Storage Unit)

FIG. 8B is a table showing the arrangement of the scroll lock condition storage unit 802 according to this embodiment. Note that FIG. 8B shows the arrangement of the scroll lock condition storage unit 802 in one table format for the sake of simplicity. However, tables according to respective conditions may be combined. The condition is not limited to those shown in FIG. 8B.

FIG. 8B shows, as a plurality of conditions, a vertical or horizontal scroll operation status 881, a scroll component 882 at each point of time, a change 883 in ratio between the vertical and horizontal components, a cumulative value (especially, the accumulation of absolute values) 884 of the vertical and horizontal components from the start point, and a vector history 885. Under these conditions, the scroll lock condition storage unit 802 stores an estimation result 886 indicating that the user does not scroll but draws a closed region representing a selected range, and scroll control 887 which is determined in accordance with the estimation result 886 and indicates whether scroll is enabled or locked.

As for the component ratio 883, the following example is provided. If, for example, there is no change equal to or larger than a predetermined threshold in the ratio between the vertical and horizontal components, it is estimated that a closed region of a selected range is not to be drawn, thereby scrolling the document in accordance with the stroke. On the other hand, if the ratio between the vertical and horizontal components tends to shift from one to the other of the vertical and horizontal components, the stroke is considered to have changed its direction, and estimated to currently draw a closed region of a selected range, thereby locking scroll. However, the components of the stroke are influenced by the fluctuation of the stroke.

If a change in ratio between the cumulative values of vertical and horizontal components of the stroke from the start point, especially the cumulative value of the absolute values of the vertical and horizontal components, is equal to or smaller than a threshold α, it is estimated that a closed region of a selected range is not currently drawn, thereby scrolling the document in accordance with the stroke. On the other hand, if a change in ratio exceeds the threshold α, it is estimated that a closed region of a selected range is currently drawn, thereby locking the scroll. Stable determination can be performed based on a change in ratio between the cumulative values.

In the vector history of the stroke, for example, if the main component of a vector is changed from the horizontal direction to the vertical direction or from the vertical direction to the horizontal direction, it is estimated that a closed region of a selected range is currently drawn, thereby locking the scroll. However, even if the direction of the main component is changed, if it is not changed again or it is changed to the opposite direction by an inflection point, it is estimated that a closed region of a selected range is not currently drawn, thereby releasing the lock of the scroll.

If there is a stroke component in the horizontal direction while scroll in the horizontal direction is disabled, or there is a stroke component in the vertical direction while scroll in the vertical direction is disabled, it is estimated that a closed region of a selected range is currently drawn, thereby locking the scroll.

Note that the scroll lock determiner 801 may perform determination by a program, instead of using the data in the scroll lock condition storage unit 802.

(Stroke Analysis Processing)

FIG. 8C is a view for explaining stroke analysis processing by the scroll lock determiner 801 according to this embodiment. FIG. 8C shows scroll lock conditions 811 and 812 and scroll lock prevention conditions 821 and 822. Note that these conditions are merely examples, and conditions are not limited to them.

The scroll lock condition 811 shows a condition for locking scroll when the absolute value |Thx| of an X component> the absolute value |Thy| of a Y component. The scroll lock condition 812 shows a condition for locking scroll when the absolute value |Thx| of an X component< the absolute value |Thy| of a Y component.

On the other hand, the scroll lock prevention condition 821 shows a condition for preventing scroll from being locked when the absolute value |Thx| of an X component< the absolute value |Thy| of a Y component. The scroll lock prevention condition 822 shows a condition for preventing scroll from being locked when the absolute value |Thx| of an X component> the absolute value |Thy| of a Y component.

(Analysis for Stroke Analysis Processing)

FIGS. 8D to 8F each show the data in the scroll lock condition storage unit 802 shown in FIG. 8B and analysis under each condition for implementing the stroke analysis processing in FIG. 8C. To create the scroll lock condition storage unit 802, a condition for estimating that the user generates a selected range of a closed region is analyzed. Note that in each of FIGS. 8D to 8F, as summarized on the right side, a change in ratio between the cumulative value of the absolute values of X components (in this example, horizontal components) and the cumulative value of the absolute values of Y components (in this example, vertical components) mainly serves as a condition for switching scroll control/scroll lock control/lock release control. As described above, using the cumulative values of the absolute values prevents a fluctuation from occurring when the ratio between the detected X and Y components is directly used.

FIG. 8D is a view for explaining the stroke analysis processing by the scroll lock determiner 801 according to this embodiment. FIG. 8D shows a case in which the scroll lock condition is analyzed when scroll in the vertical and horizontal directions is enabled. FIG. 8D shows a case in which a start point is on a stroke in the horizontal direction. If a selected range of a closed region is to be generated, a stroke changes from a stroke having a main vector in the horizontal direction to a stroke having a main vector in the vertical direction, and then changes to a stroke having a main vector in the horizontal direction. Therefore, if the main vector of the stroke changes from the horizontal direction to the vertical direction, generation of a selected range can be estimated. However, even if the main vector of the stroke changes from the horizontal direction to the vertical direction, if the main vector does not change to the horizontal direction again or the main vector is directed in the opposite direction by an inflection point, it is determined that a selected range is not to be generated. In consideration of the cumulative values of the stroke, if the central portion in the horizontal direction is set as a start point as shown in FIG. 8C, horizontal components are accumulated for a while and then the accumulation of vertical components increases. As described above, generation of a selected range can be estimated based on a change in ratio between the vertical and horizontal components of a stroke.

FIG. 8E is a view for explaining the stroke analysis processing by the scroll lock determiner 801 according to this embodiment. FIG. 8E shows a case in which the scroll lock condition is analyzed when scroll in the horizontal direction is disabled, for example, when, in the case of a document, the whole document is displayed on the screen in the horizontal direction. If scroll in the horizontal direction is disabled, generation of a selected range can be estimated at the start of scroll in the horizontal direction. In this case, scroll in the vertical direction may be locked.

FIG. 8F is a view for explaining the stroke analysis processing by the scroll lock determiner 801 according to this embodiment. FIG. 8F shows a case in which the scroll lock condition is analyzed when a start point is in the middle of the stroke. FIG. 8F shows a case in which the start point is on a stroke in the vertical direction. If a selected range of a closed region is to be generated, a stroke changes from a stroke having a main vector in the vertical direction to a stroke having a main vector in the horizontal direction, and then changes to a stroke having a main vector in the vertical direction. Therefore, if the main vector of the stroke changes from the vertical direction to the horizontal direction, generation of a selected range can be estimated. However, even if the main vector of the stroke changes from the vertical direction to the horizontal direction, if the main vector does not change to the vertical direction again or the main vector is directed in the opposite direction by an inflection point, it is determined that a selected range is not to be generated. In this case as well, if a stroke has a vertically long elliptic shape, generation of a selected range can be estimated based on the accumulation of vertical and horizontal components, similarly to FIG. 8C. However, in the case of a horizontally written document, a stroke basically has a horizontally long elliptic shape. Therefore, in the case shown in FIG. 8E, generation of a selected range is desirably estimated based on the main vector of the stroke or the ratio between the vertical and horizontal components.

Based on analysis in each of representative situations shown in FIGS. 8D to 8F, the scroll lock condition storage unit 802 is generated.

(Display Controller)

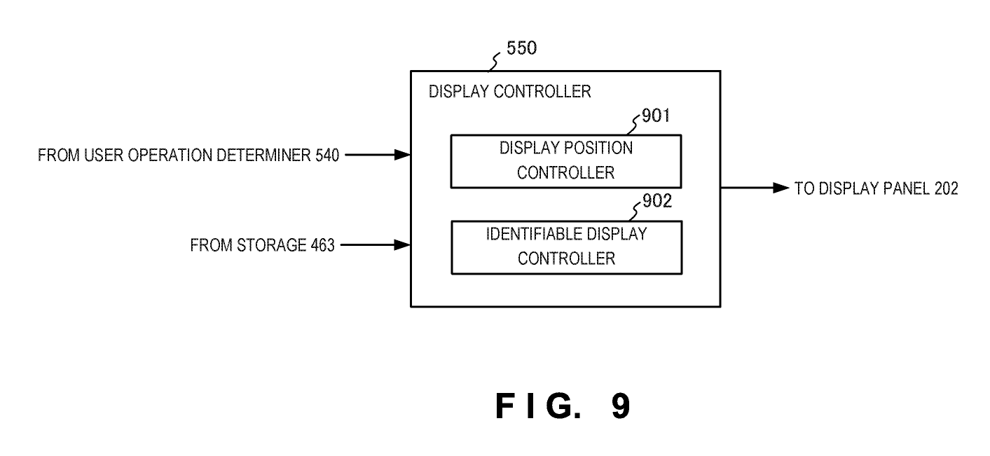

FIG. 9 is a block diagram showing the functional arrangement of the display controller 550 according to this embodiment. The display controller 550 reads out a content including a document from the storage 463, and controls screen display on the display panel 202 in accordance with the determination result of the user operation determiner 540.

The display controller 550 includes a display position controller 901 and an identifiable display controller 902. The display position controller 901 controls a position of the content read out from the storage 463 to be displayed. In this embodiment, the display position controller 901 controls the display position of the document. The identifiable display controller 902 controls to identifiably display the selected range of the document on the display screen.

<<Procedure of Screen Operation Processing>>

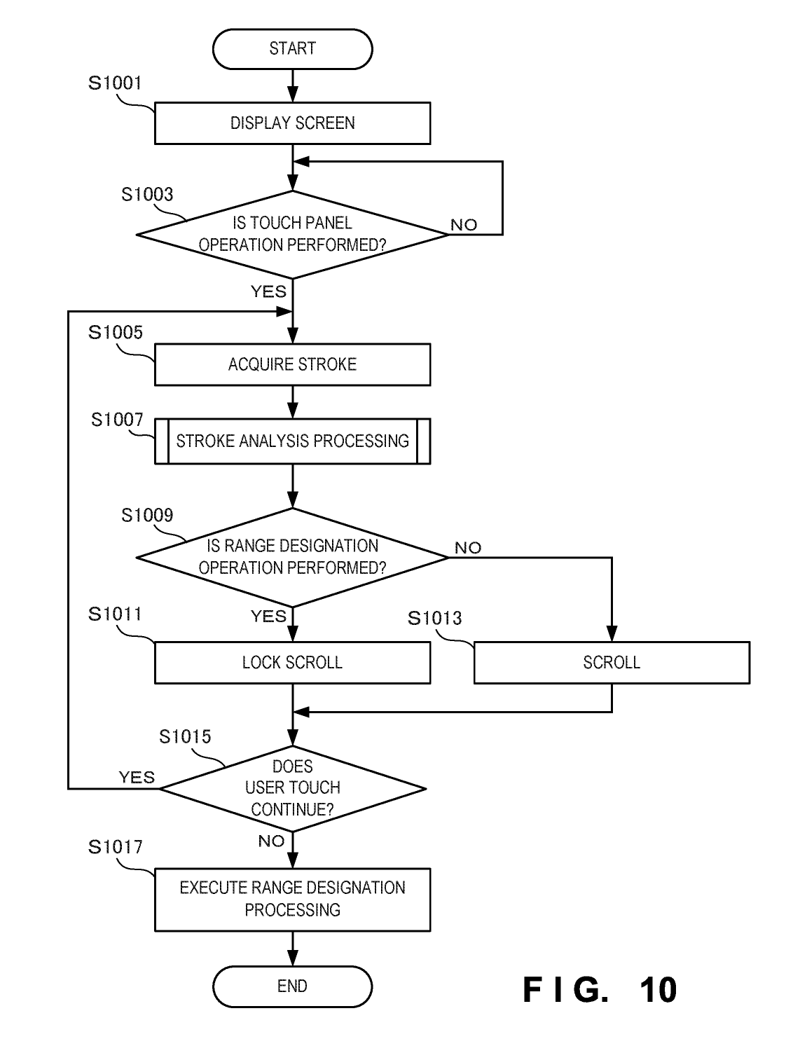

FIG. 10 is a flowchart illustrating the procedure of screen operation processing by the information processing apparatus 200 according to this embodiment. This flowchart implements the respective functional components of the screen operation processor 410 when executed by the processor 400 or the CPU of the screen operation processor 410. A case in which the CPU of the screen operation processor 410 executes the flowchart will be described.

In step S1001, the screen operation processor 410 displays a predetermined portion of a document designated, by the user, to be displayed. In step S1003, the screen operation processor 410 monitors whether the user's finger touches the touch panel 201. If a touch by the finger is detected, the screen operation processor 410 acquires a stroke in step S1005.

In step S1007, the screen operation processor 410 executes, based on the acquired stroke, stroke analysis processing of analyzing whether the contour of a closed region for designating a selected range is to be drawn. Based on the result of the stroke analysis, the screen operation processor 410 determines in step S1009 whether the stroke is to designate a selected range. If it is determined that the stroke is to designate a selected range, the screen operation processor 410 locks scroll in step S1011; otherwise, the screen operation processor 410 scrolls the document in step S1013.

If it is determined in step S1015 that the touch by the user's finger continues, the screen operation processor 410 returns to step S1005 to repeat the processing. If the user releases the finger from the touch panel 201, the screen operation processor 410 executes, in step S1017, processing corresponding to the set range designation.

(Stroke Analysis Processing)

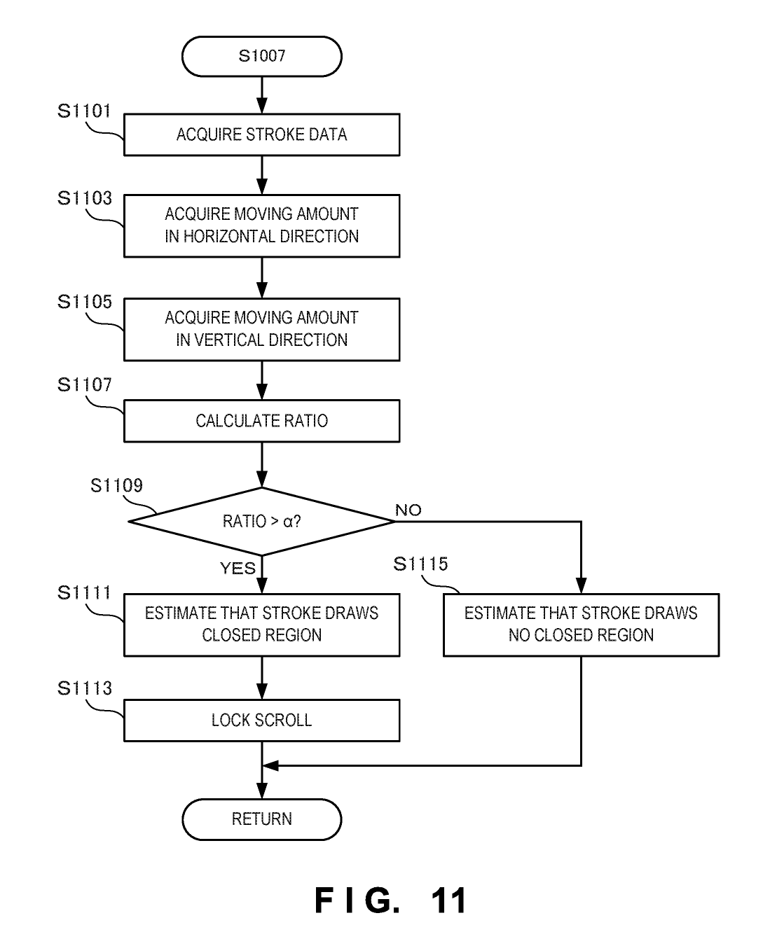

FIG. 11 is a flowchart illustrating the procedure of the stroke analysis processing (S1007) according to this embodiment.

In step S1101, the screen operation processor 410 acquires stroke data. In step S1103, the screen operation processor 410 acquires the moving amount in the horizontal direction of the stroke. In step S1105, the screen operation processor 410 acquires the moving amount in the vertical direction of the stroke.

In step S1107, the screen operation processor 410 calculates the ratio between the moving amount in the horizontal direction and that in the vertical direction, for example, the ratio of the vertical moving amount to the horizontal moving amount. In step S1109, the screen operation processor 410 determines whether the calculated ratio is larger than the predetermined threshold α. If the ratio is larger than the predetermined threshold α, the screen operation processor 410 estimates in step S1111 that the stroke draws a closed region, and determines in step S1113 to lock scroll; otherwise, the screen operation processor 410 estimates in step S1115 that the stroke draws no closed region.

According to this embodiment, if it is estimated that a shape drawn by a stroke is a closed region for range designation, scroll is locked and it is controlled to allow the user to surely designate a range, thereby implementing sufficiently user-friendly screen control.

### Third Embodiment

An information processing apparatus according to the third embodiment of the present invention will be described next. The information processing apparatus according to this embodiment is different from that according to the second embodiment in that if, in stroke analysis, a stroke of a component in the first direction is detected on a screen which is not scrolled in the first direction, scroll in the second direction orthogonal to the first direction is locked. The remaining components and operations are the same as those in the second embodiment. Hence, the same reference numerals denote the same components and operations, and a detailed description thereof will be omitted.

(Stroke Analysis Processing)

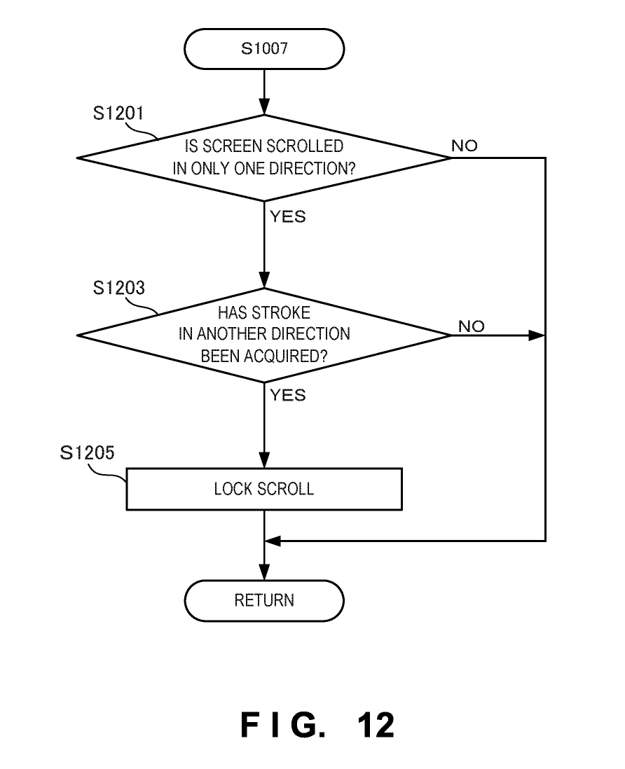

FIG. 12 is a flowchart illustrating the procedure of stroke analysis processing (S1007) according to this embodiment.

In step S1201, it is determined whether a display screen is a screen which can be scrolled in only one direction. If the display screen is a screen which can be scrolled in both the horizontal and vertical directions, NO is determined to end the processing of this flowchart. If the display screen is a screen which can be scrolled in only one of the horizontal and vertical directions, the process advances to step S1203.

In step S1203, it is determined whether a stroke acquired in step S1005 is that in a direction (for example, the horizontal direction) different from the scrollable direction (for example, the vertical direction).

If it is determined that the stroke in the direction (for example, the horizontal direction) different from the scrollable direction (for example, the vertical direction) has been acquired, the process advances to step S1205 to perform scroll lock control.

As described above, according to this embodiment, since scroll is locked in response to detection of a stroke in multiple directions on a screen which can be scrolled in only one direction, it is possible to perform more user-friendly scroll lock control.

### Fourth Embodiment

An information processing apparatus according to the fourth embodiment of the present invention will be described next. The information processing apparatus according to this embodiment is different from that according to the second embodiment in that a user operation is detected to lock scroll, and the lock is released under a condition. The remaining components and operations are the same as those in the second embodiment. Hence, the same reference numerals denote the same components and operations, and a detailed description thereof will be omitted.

(Procedure of Screen Operation Processing)

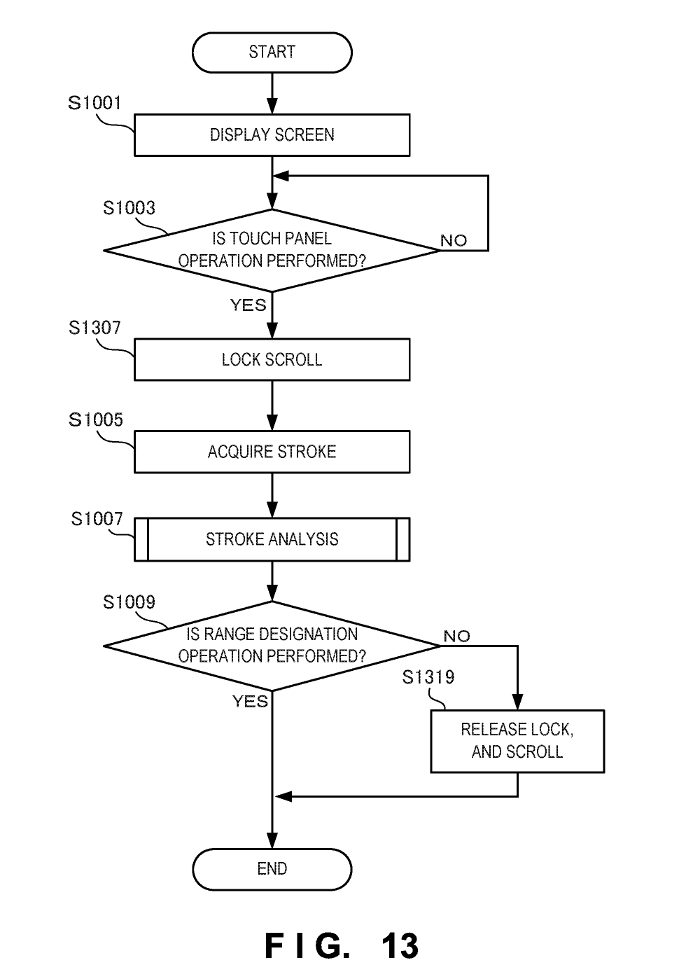

FIG. 13 is a flowchart illustrating the procedure of screen operation processing by the information processing apparatus according to this embodiment.

Referring to FIG. 13, if a display controller 550 detects an operation on a touch panel, it performs, in step S1307, scroll lock control for a stroke of a predetermined distance. If, as a result of stroke analysis in step S1007, it is determined in step S1009 that the operation is not a range designation operation, the process advances to step S1319, and the lock of scroll is released to scroll a document.

As described above, according to this embodiment, when a touch panel operation is accepted, scroll is locked, and the lock of scroll is released under a predetermined condition. Thus, it is possible to perform more user-friendly scroll lock control.

### Fifth Embodiment

An information processing apparatus according to the fifth embodiment of the present invention will be described next. The information processing apparatus according to this embodiment is different from that according to the second embodiment in that scroll is locked in accordance with a change in ratio of a component in the vertical direction to a component in the horizontal direction of a vector at each point on a stroke. The remaining components and operations are the same as those in the second embodiment. Hence, the same reference numerals denote the same components and operations, and a detailed description thereof will be omitted.

(Stroke Analysis Processing)

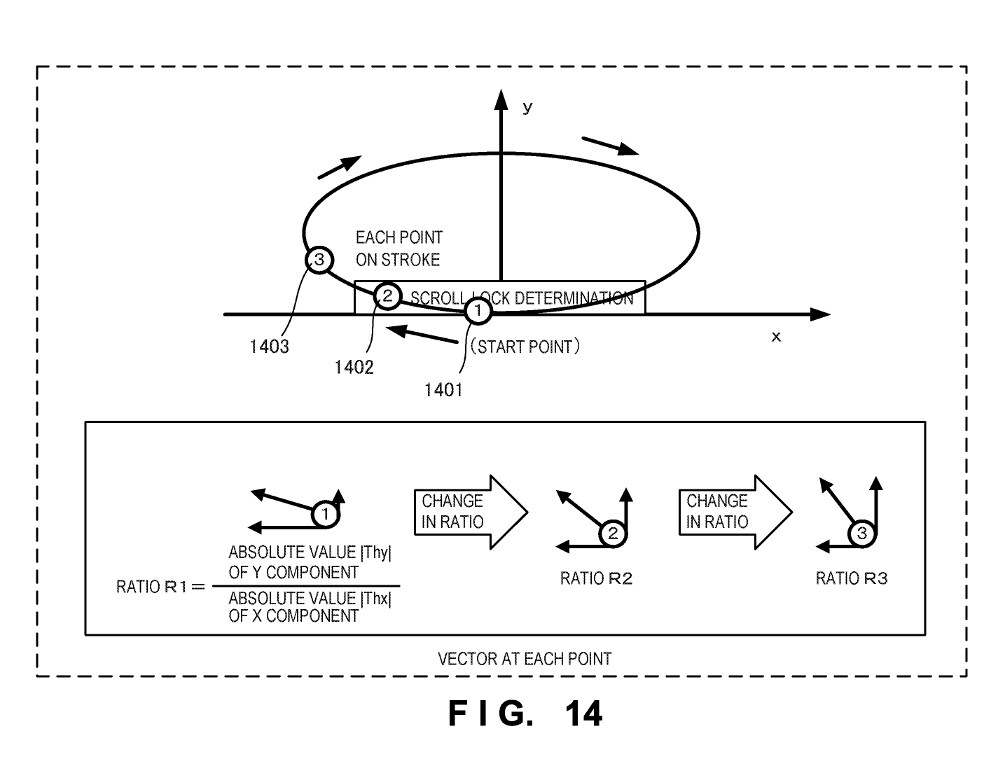

FIG. 14 is a view for explaining stroke analysis processing by the information processing apparatus according to this embodiment.

In FIG. 14, assume that a stroke draws a locus from a point 1401 to a point 1403 through a point 1402. In this case, the value of a ratio R=(an absolute value |Thy| of a Y component/an absolute value |Thx| of an X component) satisfies R1 (point 1401)<R2 (point 1402)<R3 (point 1403). If the ratio changes in this way, the movement of a user's finger on a touch panel 201 is estimated to draw a locus surrounding a closed region for range selection, thereby locking scroll.

As described above, according to this embodiment, when a touch panel operation is accepted, scroll is locked, and kept locked under a predetermined condition, thereby making it possible to perform more user-friendly scroll lock control.

Alternatively, a change in direction of a stroke may be detected. If the direction of a stroke is changed, scroll lock control may be performed.

### OTHER EMBODIMENTS

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

The present invention is applicable to a system including a plurality of devices or a single apparatus. The present invention is also applicable even when an information processing program for implementing the functions of the embodiments is supplied to the system or apparatus directly or from a remote site. Hence, the present invention also incorporates the program installed in a computer to implement the functions of the present invention by the computer, a medium storing the program, and a WWW (World Wide Web) server that causes a user to download the program. Especially, the present invention incorporates at least a non-transitory computer readable medium storing a program that causes a computer to execute processing steps included in the above-described embodiments.

This application claims the benefit of Japanese Patent Application No. 2014-059239 filed on Mar. 20, 2014, which is hereby incorporated by reference herein in its entirety.

What is claimed is:

1. An information processing apparatus that acquires a stroke from a user operation on a touch panel, and locks a scroll operation by the stroke, if the user operation by the stroke is estimated to draw a contour of a closed region.

2. The information processing apparatus according to claim 1, wherein the information processing apparatus locks a scroll operation by a stroke of a predetermined distance from a start of the stroke, and releases the lock of the scroll operation, if the user operation is not estimated to draw the contour of the closed region.

3. The information processing apparatus according to claim 1, wherein the information processing apparatus estimates the user operation to draw the contour of the closed region based on a ratio between a moving amount in a horizontal direction and a moving amount in a vertical direction of the stroke.

4. The information processing apparatus according to claim 3, wherein the information processing apparatus locks the scroll operation by the stroke, if the ratio between the moving amount in the horizontal direction and the moving amount in the vertical direction changes.

5. The information processing apparatus according to claim 1, wherein the information processing apparatus locks a scroll operation in a second direction orthogonal to a first direction, if a stroke of a component in the first direction is detected on a screen which is not scrolled in the first direction.

6. An information processing method comprising:
acquiring a stroke from a user operation on a touch panel;
determining whether the operation by the stroke can be estimated to draw a contour of a closed region; and
locking a scroll operation by the stroke, if the operation by the stroke is estimated to draw the contour of the closed region.

7. A non-transitory computer-readable storage medium storing an information processing program for causing a computer to execute a method, comprising:
acquiring a stroke from a user operation on a touch panel;
determining whether the operation by the stroke can be estimated to draw a contour of a closed region; and
locking a scroll operation by the stroke, if the operation by the stroke is estimated to draw the contour of the closed region.
